(19) United States
(12) Patent Application Publication
(10) Pub. No.: US 2023/0221630 A1
(43) Pub. Date: Jul. 13, 2023

(54) TRAFFIC CONTROL PROJECTOR

(71) Applicant: Manuel Ayala, Chicago, IL (US)

(72) Inventor: Manuel Ayala, Chicago, IL (US)

(21) Appl. No.: 18/095,036

(22) Filed: Jan. 10, 2023

Related U.S. Application Data
(60) Provisional application No. 63/297,944, filed on Jan. 10, 2022.

(51) Int. Cl. G03B 23/08; G03B 21/12; G03B 21/20; G08G 1/09

(52) U.S. Cl. CPC G03B 23/08; G03B 21/12; G03B 21/2033; G08G 1/09

(57) ABSTRACT

A handheld, battery powered projection device for projecting a traffic command image onto a road surface. The projection device uses a laser light source to project the traffic command image. The projection device includes a twist actuator for selecting from a plurality of projectable traffic command images.

### CROSS-REFERENCE

This application claims the priority benefit of U.S. Provisional Pat. App. No. 63/297,944, filed Jan. 10, 2022, entitled “TRAFFIC CONTROL PROJECTOR,” which is hereby incorporated by reference herein in its entirety.

### FIELD OF THE DISCLOSURE

The present disclosure relates to handheld still image projectors, more particularly those adapted to produce readily visible projected images on outdoor surfaces in outdoor lighting conditions.

### SUMMARY

According to an aspect of the disclosure, a handheld image projector comprises a housing, a light source, a power source, an image selection actuator, and a projection switch. The housing has an aperture, and the light source is disposed within the housing, being operative to project a plurality of selectable images through the aperture in the housing and onto an outdoor surface. In embodiments, the light source comprises one or more lasers. More particularly, the light source is a laser array. In embodiments, the laser array includes at least forty light-emitting diodes (LEDs). The power source is being operatively connected to the light source and supported by the housing. The image selection actuator is adapted to be actuated by a user to a plurality of actuation states (e.g., rotated dial positions) corresponding to the plurality of selectable images, and operative, when actuated to one of the actuation states, to select the corresponding one of the selectable images. The projection switch has on and off positions and is adapted and configured to be switched on when in the on position and switched off when in the off position. In embodiments, the projection switch is further adapted and configured to passively return to the off position when released, as in a spring-loaded button-type contact switch. When switched on, the projection switch is operative to cause the power source to energize the light source so as to project the selected image, and the projection switch being operative when switched off to cause the power source to stop energizing the light source so that the light source stops projecting the selected image. In more particular embodiments, the projector comprises a dedicated, second projection switch, the second projection switch being operative always to cause the light source to project the same image when switched on, irrespective of the actuation state of the image selection actuator.

In a method according to another aspect of the disclosure, a user actuates the image selection actuator to one of the actuation states corresponding to a selected image, holds and aims the projector at an outdoor surface and actuates the projection switch to project an image onto the outdoor surface. In embodiments, the image is a traffic command image.

### BRIEF DESCRIPTION OF THE DRAWINGS

Although the characteristic features of this disclosure will be particularly pointed out in the claims, the disclosed method and system, and how it may be made and used, may be better understood by referring to the following description taken in connection with the accompanying drawings forming a part hereof, wherein like reference numerals refer to like parts throughout the several views and in which:

FIG. 1A is a perspective view of a handheld still image projector constructed in accordance with this disclosure;

FIG. 1B is a perspective view of another embodiment of a handheld still image projector constructed in accordance with this disclosure;

FIG. 2 is an illustration of selectable still images that can be projected by the projector of FIG. 1A or FIG. 1B in a method in accordance with this disclosure;

FIG. 3 is an illustration of a method of using the projector of FIG. 1A or FIG. 1B to direct traffic at a roadway intersection.

A person of ordinary skill in the art will appreciate that elements of the figures above are illustrated for simplicity and clarity and are not necessarily drawn to scale. The dimensions of some elements in the figures may have been exaggerated relative to other elements to help to understand the present teachings. Furthermore, a particular order in which certain elements, parts, components, modules, steps, actions, events and/or processes are described or illustrated may not be required. A person of ordinary skill in the art will appreciate that, for simplicity and clarity of illustration, some commonly known and well-understood elements that are useful and/or necessary in a commercially feasible embodiment may not be depicted to provide a clear view of various embodiments per the present teachings.

### DETAILED DESCRIPTION

In the following description of various examples of embodiments of the disclosed device and method, reference is made to the accompanying drawings, which form a part hereof, and in which are shown by way of illustration various example devices, systems, and environments in which aspects of the disclosed device and method can be practiced. Other specific arrangements of parts, example devices, systems, and environments, can be used, and structural modifications and functional modifications can be made without departing from the scope of the disclosed device and method.

As illustrated in the accompanying drawings and described herein, the present disclosure provides a battery-operated, rechargeable handheld laser projector approximately the size of an LED flashlight, adapted for use by an on-site traffic control officer to project images of a traffic control sign or instruction on an outdoor surface, more particularly, a road surface.

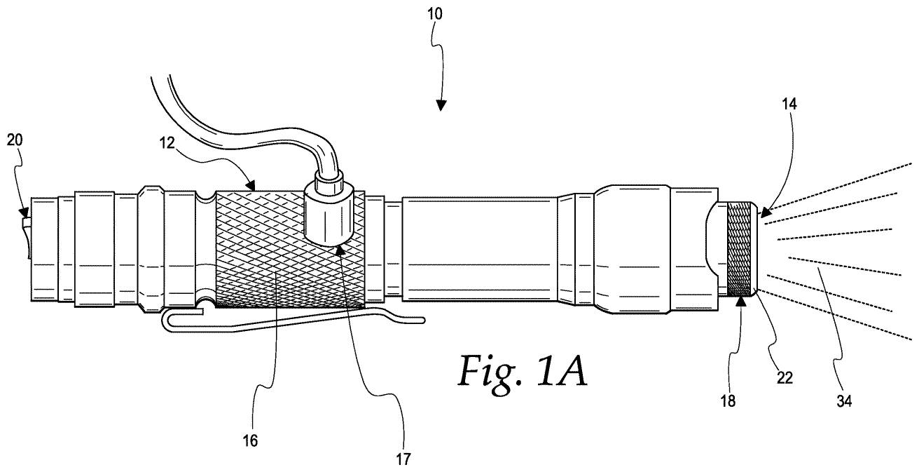

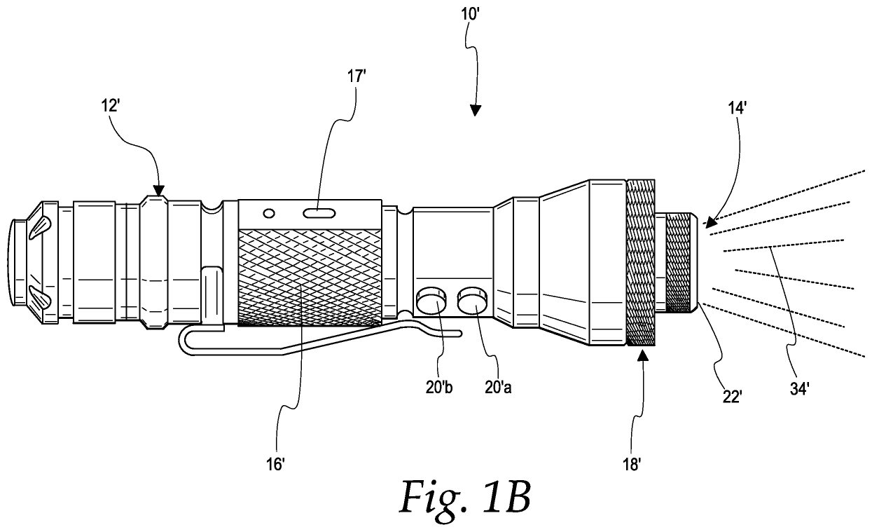

One embodiment is illustrated as a projector 10, shown in FIG. 1A. The projector 10 includes a housing 12, the housing 12 enclosing, retaining, and/or supporting a light source 14, a power source 16 that is rechargeable through a charge port 17 (such as a lithium or other suitable type of battery that is rechargeable via a USB or other suitable charge port), an image selection actuator 18, and a projection switch 20 for energizing and de-energizing (turning on and off) the light source 14, illustrated as a rocker switch on a back end of the housing 12. The rocker projection switch 20 can be adapted and configured to have stable on and off positions and operative, when moved by a user to the on position (as shown in FIG. 1A), to remain in the on position when released, so as to energize the light source 14 so as to emit a beam of light 34, and when moved to the off position (not shown), to remain in the off position when released, so as to de-energize the light source 14 so as to cease emitting light. The housing 12 has an aperture 22 formed therein, the light source 14 being adapted and configured, when energized, to emit the beam of light 34 so as to project a selected traffic command image through the aperture 22 onto an outdoor surface.

Another embodiment is illustrated as a two-button projector 10′, shown in FIG. 1B. The projector 10′ includes a housing 12′, the housing 12′ enclosing retaining, and/or supporting a light source 14′, a power source 16′ that is rechargeable through a charge port 17′ (such as a lithium or other suitable type of battery that is rechargeable via a USB or other suitable charge port), an image selection actuator 18′, and projection switches 20′a, 20′b, which are illustrated as a first button projection switch 20′a and a second button projection switch 20′b. In embodiments, the first button projection switch 20′a and second button projection switch 20′b can each be operable to energize the light source 14′ so as to emit a beam of light 34′ of a respective first color or second color, the second color being different from the first color. For example, the first button projection switch 20′a can be operable to energize the light source 14′ so as to emit a green beam of light 34′, and the second projection switch 20′b can be operable to energize the light source 14′ so as to emit a red beam of light 34′. More particularly, the button projection switches 20′a, 20′b can be contact switches that are operable to energize the light source 14′ only when manually depressed to and held in an “on” position, such as by the thumb of a user, and when released, to spring back to an “off” position so as to de-energize the light source 14′. In other embodiments, the button projection switches 20′a, 20′b are toggle switches operative to change from their current on/off state to the other state each time the switch is pressed and released. The housing 12′ has an aperture 22′ formed therein, the light source 14′ being adapted and configured, when energized, to emit the beam of light 34′ so as to project a selected traffic command image through the aperture 22′ onto an outdoor surface.

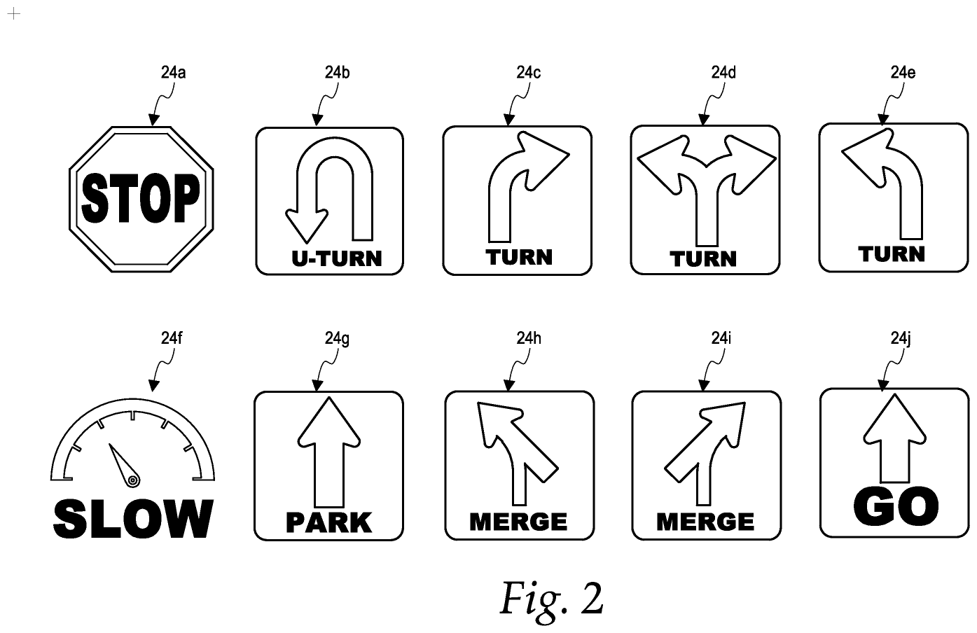

A plurality of exemplary projectable traffic command images 24a-24j, which can be selected individually for projection by twisting the image selection actuator 18, 18′, are illustrated in FIG. 2. The image selection actuator 18, 18′, depicted in the drawings as rotatable dials, allow the user to select a particular traffic command image, such as “go,” “turn left,” “turn right,” etc. by actuating the actuator 18, 18′ to an actuation state corresponding to the selected image. The actuation state of such a dial can be one of a plurality of rotated positions of the dial, each corresponding to a respective one of the plurality of projectable traffic command images 24a-24j.

In embodiments of the two-button projector 10′, the first button projection switch 20′a is always operative to project the same image, such as the “stop” command image 24a, irrespective of the actuation state (e.g., the rotated position) of the image selection actuator 18′. More particularly, in embodiments in which the first and second switches 20′a, 20′b are used to project images using respective first and second colors of the light beam 34′, the first switch 20′a itself can have a button of the first color, for example a green button, and the second switch 20′b can have a button of the second color, for example a red button. Advantageously, a user can thus use the two-button projector 10′ to project a dedicated image on-the-fly, in a simple, intuitive and consistent manner by simply pressing a dedicated button for projecting that image. For example, the user can project the “stop” command image 24a in red light by simply pressing a red button of the second switch 20′b at any time. It is believed that this can reduce the risk of an unintended image being projected by mistake.

In addition, the selection of images that can be projected using the first switch 20′a can either exclude or redundantly include the dedicated image that is always projected by operation of the dedicated second switch 20′b. In the latter case, in embodiments in which the first switch 20′a and the second switch 20′b are generally operable to project the light beam 34′ in respective first and second colors as previously described, the first switch 20′a can nonetheless be operative to project the second color of light when projecting that particular image is selected. In still more particular embodiments, each first and second button switch 20′a, 20′b is a toggle switch that is operative only when a separate power switch (not shown) is switched on and the image corresponding to the other button switch 20′a, 20′b is being projected. That is, the first button switch 20′a is operative, when toggled, only to change the projected image to the selected image (in more particular embodiments, in the first color), and the second button switch 20′b is operative only to change the projected image to the dedicated image (in more particular embodiments, in the second color), and only when the respective image is not already being projected.

In a method of using the projector 10 or the projector 10′ according to this disclosure, a user actuates the image selection actuator 18, 18′ to an actuation state corresponding to a selected image (such as one of the traffic command images 24a-24j), holds the projector 10, 10′ aimed at an outdoor surface and then engages the projection switch 20 of the projector 10 or the first button projection switch 20′a of the projector 10′. The selected image is then projected onto the surface at which the projector 10, 10′ is aimed. In embodiments of a method of using the two-button projector 10′, when the user engages the second button projection switch 20′b, a dedicated image (such as the traffic “stop” command image 24a) is always projected.

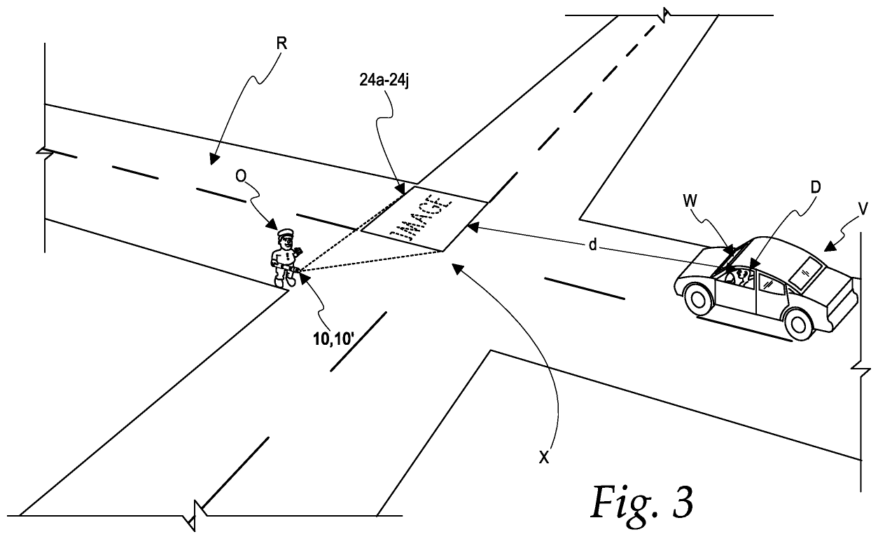

More particularly, as shown in FIG. 3, an officer O uses the projector 10, 10′ to project a traffic command image 24a-24j onto a driving surface such as a roadway R, and still more particularly onto a roadway R within an intersection X for which the officer O is directing traffic. The traffic command image 24a-24j will be of sufficient size and brightness to be easily seen by all approaching drivers. For example, light source 14, 14′ and the aperture 22, 22′ are adapted and configured to project portions of the image 24a-24j at sufficiently divergent angles so that, when the projector 10, 10′ is held at a height that is comfortable for the officer O, such as the hip height of a typical adult, such as that of an adult between five- and six-feet tall, the traffic command image 24a-24j spans the width and length of at least a ten-foot by ten-foot projection area of the driving surface, when the horizontal distance from the nearest side of the projection area to the aperture 22, 22′ is no more than forty-five feet, and more preferably no more than thirty feet. The brightness of the light source 14, 14′ can, in certain embodiments, further be adapted so as to limit the risk of harm from a beam of light 34, 34′ emanating from the light source 14, 14′ directly impinging on a human eye for a short time. In embodiments, the light source 14, 14′ comprises a class 2 laser or a class 3R laser. More particularly, the laser light source 14, 14′ can have a power output of less than 5 mW, more particularly less than 2.5 mW, and still more particularly no more than 1 mW, with a divergence no less than 0.5 mrad, and more particularly no less than 1.0 mrad. In certain embodiments, the light source 14, 14′ can be a laser array that will have a total power output of approximately 100 mW spread across forty or more LEDs.

The light source 14, 14′ is adapted and configured to project the selected traffic command image 24a-24j through the aperture 22, 22′, so that the projected traffic command image 24a-24j is recognizable to a driver D of normal, unaided vision through an ordinary front windshield, from a distance d such as would allow a reasonable time for the driver to react to a traffic command corresponding to the projected traffic command image 24a-24j, as the driver approaches a road section, depicted as an intersection X, that is controlled by the traffic command, when the driver D is driving at a reasonable speed. For example, in nighttime outdoor ambient light conditions, the traffic command corresponding to the traffic command image 24a-24j is visually recognizable to the approaching driver from a distance d of at least 15 feet, preferably from a distance of at least 60 feet, and more preferably from a distance of at least 90 feet.

In addition, in embodiments of the two-button projector 10′ that project images in two different colors of light, the approaching driver of normal unaided vision is able under such conditions and from such distances to discern the color of the traffic command image, more preferably from a distance of at least sixty feet, and still more preferably from a distance of at least one-hundred twenty feet. Still more preferably, such an approaching driver is able to correctly identify from such distances the color of the image projected by the second button projection switch 20′b as the second color (for example, “red”) without knowing that the images can only be of the first color or the second color.

The preceding description of the disclosure has been presented for purposes of illustration and description and is not intended to be exhaustive or to limit the disclosure to the precise form disclosed. The description was selected to best explain the principles of the present teachings and the practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification but be defined by the claim(s) set forth below. In addition, although narrow claims may be presented below, it should be recognized that the scope of this disclosure is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional disclosures are not dedicated to the public and the right to file one or more applications to claim such additional disclosures is reserved.

What is claimed is:

1. A handheld image projector comprising
a housing, the housing having an aperture;
a light source within the housing, the light source being operative to project a plurality of selectable images through the aperture in the housing and onto an outdoor surface;
a power source, the power source being operatively connected to the light source and supported by the housing;
an image selection actuator, the image selection actuator being adapted to be actuated by a user to a plurality of actuation states corresponding to the plurality of selectable images, and operative, when actuated to one of the actuation states, to select the corresponding one of the selectable images; and
a projection switch, the projection switch having on and off positions and being adapted and configured to be switched on when in the on position and switched off when in the off position, the projection switch being operative when switched on to cause the power source to energize the light source so as to project the selected image, and the projection switch being operative when switched off to cause the power source to stop energizing the light source so that the light source stops projecting the selected image.

2. The handheld image projector of claim 1 wherein the light source projecting said plurality of images through the aperture comprises the light source projecting a beam of light through the aperture.

3. The handheld image projector of claim 2 wherein the light source comprises a laser light source selected from a class 2 laser and a class 3R laser.

4. The handheld image projector of claim 3 wherein the laser light source has a power output of less than 5 mW.

5. The handheld image projector of claim 4 wherein the laser light source has a divergence no less than 0.5 mrad.

6. The handheld image projector of claim 3 wherein the light source comprises a laser array including at least forty LEDs.

7. The handheld image projector of claim 2 wherein the projection switch is a first projection switch, further comprising a second projection switch, the second projection switch having on and off positions and being adapted and configured to be switched on when in the on position and switched off when in the off position, the second projection switch being operative, when switched on, to cause the power source to energize the light source so as to project a dedicated image irrespective of the actuation state of the image selection actuator.

8. The handheld image projector of claim 7 wherein the dedicated image is one of the plurality of selectable images.

9. The handheld image projector of claim 7, further comprising the first projection switch being so operative, when switched on, that the beam of light projected by the light source is of a first color, the second projection switch being so operative, when switched on, that the beam of light projected by the light source is of a second color, the second color being different from the first color.

10. The handheld image projector of claim 7 wherein the first projection switch is a first button projection switch comprising a first button and the second projection switch is a second button projection switch comprising a second button, each of the first and second button projection switches being adapted and configured to be switched on when the respective first or second button is depressed by a user and then to be switched off when the respective first or second button is released by the user.

11. The handheld image projector of claim 1 wherein the image selection actuator comprises a rotatable dial, the plurality of actuation states comprising a corresponding plurality of rotated positions of the rotatable dial.

12. The handheld image projector of claim 1 wherein the projection switch has stable on and off positions and is operative, when moved to the on position and released, to cause the power source to so energize the light source, and when moved to the off position and released, to cause the power source to so stop energizing the light source.

13. A method of using a handheld image projector to project an image onto an outdoor surface, the handheld image projector comprising a housing, a light source within the housing, a power source, an image selection actuator that is actuatable to a plurality of actuation states for a corresponding plurality of selectable images, and a projection switch, the method comprising:
actuating the image selection actuator to one of the actuation states corresponding to a selected one of the selectable images;
holding the projector aimed at the outdoor surface; and
moving the projection switch to an on position to cause the power source to energize the light source so as to project the selected image onto the outdoor surface.

14. The method of claim 13 wherein the projection switch is a first projection switch, the handheld image projector further comprising a second projection switch for projecting a dedicated image, the dedicated image being different from the selected image, the method further comprising moving the second projection switch to an on position to cause the power source to energize the light source so as to project the dedicated image onto the outdoor surface.

15. The method of claim 13 wherein the outdoor surface is a driving surface and the selected image is a traffic command image.

16. The method of claim 15 wherein the driving surface is a roadway surface within an intersection.

17. The method of claim 15 wherein the selected image is recognizable to a driver of normal, unaided vision through an ordinary front windshield, in nighttime outdoor ambient light conditions, from a distance of at least 15 feet.

18. The method of claim 15 wherein the selected image is recognizable to a driver of normal, unaided vision through an ordinary front windshield, in nighttime outdoor ambient light conditions, from a distance of at least 60 feet.

19. The method of claim 15 wherein the selected image is recognizable to a driver of normal, unaided vision through an ordinary front windshield, in nighttime outdoor ambient light conditions, from a distance of at least 90 feet.
